(19) United States
(12) Patent Application Publication
(10) Pub. No.: US 2007/0013088 A1
(43) Pub. Date: Jan. 18, 2007

(54) Method of construction of a carburetor for automotive use

(76) Inventor: Bruce Martin Robertson, Adelaide (AU)

Correspondence Address: BRUCE MARTIN ROBERTSON, 30 GRANDVIEW GROVE REYNELLA, ADELAIDE, 5161, AU

(21) Appl. No.: 11/180,805

(22) Filed: Jul. 14, 2005

(51) Int. Cl. F02M 23/12

(52) U.S. Cl. 261/115; 261/DIG. 55

(57) ABSTRACT

A carburetor utilizing a compact main fuel delivery device that provides fine droplets of fuel spread across an airflow orifice. The main fuel delivery device does not require the use of a main jet or emulsion well prior to the point of the fuel interacting with the atmosphere of the air flow orifice or venturi. The airflow orifice and other mixture forming components of the carburetor are contained within plates and formed by the assemblage of the plates. A centrally located bolt provides the securing and sealing force necessary for operation of the carburetor. The entire above the fuel level mixture controlling systems can be removed from the carburetor after unfastening the central bolt. It is not necessary to drain the carburetor of fuel to change the jetting or other settings of the carburetor.

### BACKGROUND

1. Field of invention

This invention relates to carburetors with a plurality of fuel orifices used in an individual airflow orifice.

2. Prior Art

The principal of maintaining a desired fuel to air ratio by introducing air into an emulsion chamber to correct for otherwise enrichment of the mixture that would occur due to single point sensing has been the main method of choice for fixed venturi carburetor manufacturers.

This is commonly called the auto-correcting carburetor principle. The early designs of fixed venturi carburetors sensed the air velocity at the center of a venturi by a tube inserted into and cut off at the centerline of the venturi. The opposing end of this tube was submersed into the fuel chamber. An increasing air volume discharging through the venturi caused sufficient pressure differential between the end of the tube inserted onto the fuel chamber and the end of the tube in the venturi to cause fuel to flow into the center of the venturi. This method meant that the fuel ratio could be determined by the use of an orifice, commonly called a jet, placed for convenience at the base of the tube. It was soon realized that additional control was needed because of the pressure gradient of the air across the diameter of the venturi. This effect resulted in increasing richness of the fuel to air ratio as the volume of airflow increased. A satisfactory solution was found in the invention of the auto-correcting principle.

Part of the auto-correcting principle involves the use of an emulsion tube. The emulsion tube allows controlled air introduction. The introduced air thereby acting as a compensating medium into the fuel delivery tubes by reducing the volume of fuel delivered. The emulsion tube is sometimes tapered to alter the pressure along the length of the emulsion tube.

A further part of the auto-correcting principle involves the use of a main venturi with a smaller venturi located so as to have some communication of effect between the two venturi. The smaller venturi also has the fuel emulsion system connected to it. The volume of fuel exiting into the small venturi gradually restricts the volume of air passable by the small venturi thus causing a mixture ratio change. Various techniques of jetting of fuel passages and or air passages and pressure take off points combine to control the fuel to air ratio the engine receives. The head of pressure of fuel above the main jet located at the entrance to the emulsion tube also affects the volumes of air and fuel introduced.

The use of the emulsion tube to correct mixture control requires the emulsion tube to be vertically arranged because the use of gravity is a principle factor of control. This has resulted in carburetors where the tuning components are mounted on the side or are accessed from the top by time-consuming disassembly. Carburetors such as the 4-venturi downdraft modular design used by the HOLLEY Corporation require draining of the fuel bowls before a main jet may be changed. This style of carburetor principally has only the idle mixture and some emulsion air bleed jets that are externally adjustable without fuel drainage.

The emulsion tube correction techniques are difficult to understand and the vast majority of skilled people undertake only basic tuning. Highly skilled tuning specialists tune multiple carburetors for use on a racing engine within ranges of atmospheric conditions. This results in motor racing teams holding multiple carburetors at great expense preset for different track and atmospheric conditions etc.

### OBJECTS AND ADVANTAGES

It is the object of this application to provide a carburetor that is easy and fast to tune to an engine and or performance requirement, that does not have to be drained of fuel to modify the tune.

Advantages of the carburetor presented.
1. The droplet size of the fuel is easily controlled resulting in optimum atomization and therefore improved vaporization of the liquid fuel.
2. The affect of fuel level height upon the mixture ratio is reduced compared to emulsion well designs.
3. Fewer components perform the metering function.
4. There is no need to drain fuel from the carburetor prior to performing a tuning operation so less hydrocarbon emissions occur.
5. The time spent to alter the mixture ratio control of the carburetor is reduced compared to other designs.
6. It is not necessary to design the carburetor for vertical orientation of use as the mixture-controlling device may be used in side draught configuration.
7. The carburetor components may be included as part of a fuel injection system.
8. The liquid distribution device-jetting rate is easy to accurately alter within very fine tolerance.
9. The work of tuning the carburetor is performed remote from the engine as the tunable elements of the carburetor are easy to remove and operate on.
10. The ease of changing the carburetor settings means the engine can be easily changed for different performance criteria such as fuel economy, emission compliance, and high or low power production.
11. Security of the engine is improved because the functioning parts of the carburetor can be quickly removed or replaced by blanks thus disabling the engine.
12. The carburetor is easily machined from billet aluminum. This increases strength and heat durability over die cast carburetors.
13. The carburetor may be produced in a low profile design with the plates forming the lid of the float bowls. This improves vision especially when mounted on top of a supercharger.
14. The carburetor can be fabricated with basic skills using tubes and plates in exotic materials such as titanium for extremely lightweight advantages.
15. The carburetor has a long life cycle due to the ease of changing the Cubic Feet per Minute flow capacity for use on other size engines.
16. There is a well-accepted market of existing carburetor designs and this carburetor is conventional in appearance for consumer acceptance.
17. There is an existing network of racing distribution shops willing to sell advances in technology.
18. The carburetor may be converted from petrol to methanol and back again in seconds.
19. The liquid distribution device achieves an essentially flat air fuel ratio line in a simple part that is easily changed for richer or leaner mixtures.
20. The throttle response of the engine is improved because the vacuum generated at the liquid distribution device surface is able to quickly lit the fuel level to the exit jets due to there being no forms of jetting prior to the liquid distribution device.
21. Because of the improved jet response speed the reliance upon accelerator pumps is reduced and this results in fuel saving and better emissions.
22. The idle system produces better atomization and a better manifold distribution.
23. The passages of the carburetor are easy to clean and inspect.

Disadvantages of common emulsion well type carburetors.
1. The droplet size substantially increases as venturi air speed decreases resulting in poor performance at low engine rpm full throttle operation.
2. The combinations of emulsion wells that need to be produced are large and contribute to high cost of manufacture.
3. The cost to consumers that wish to improve the tune of their carburetor is high.
4. Changing the mixture by altering the main jet size alters the air fuel ratio curve necessitating re configuration of the emulsion well design.
5. Altering the fuel inlet needle and seat size or fuel pressure disrupts the emulsion well calibration.
6. The effects of G-Force upon the emulsion well fuel level causes inaccurate fuel delivery.
7. Different emulsion well calibration is needed for different types of fuel e.g. gasolines or alcohols. This is due to the higher flow requirement of alcohol fuels affecting the air correction necessary. This makes it difficult to convert the carburetor from one fuel to the other.
8. In most of the typical emulsion style carburetors altering the idle transfer system air bleed and or jet alters the main circuit mixture, therefore requiring assessment and correction of that circuit as well.
9. Throttle response of the main fuel circuit is slow because of the reduced vacuum action upon the fuel level height due to the introduced air leaks in the main emulsion well system.
10. The idle system reduces the atomization of the idle fuel by passing the atomized mixture through a mixture adjusting restriction before entering the manifold of the engine.
11. The passages of the carburetor are difficult to clean.

Further objects and advantages of my invention will become apparent from a consideration of the drawings and ensuing description.

### SUMMARY OF THE INVENTION

The carburetor presented by the inventors overcomes disadvantages of conventional emulsion well type carburetors. The tuning of the mixture is simpler with no change in fuel curve shape when the main jet is changed in size. The carburetor enables quick and simple changing of all the tuning features of the carburetor. A simple plate assembly may be quickly changed in a few seconds, thereby effectively replacing the main devices controlling the fuel mixture metering of the carburetor without draining fuel. This method greatly reduces the cost to teams with multiple carburetor combinations. The carburetor is constructed with a chassis to enable modular construction and assembly. The fuel mixture control systems are contained within and formed by the assembly of plates attached to the air entrance face of the chassis. The fuel supply or reservoir systems are attached to the side of the chassis. A throttling plate attached to the base of the chassis controls the regulation of airflow rate through the carburetor. The throttling plate may contain inserted plates to assist in control of fuel mixture.

The construction of the carburettor involves various levels and functions sandwiched on top of each other, with each level/functional unit easily and quickly removable and replaceable. This provides far greater flexibility in quickly modifying or tuning the carburetion of an engine.

The carburettor utilizes a simple principle metering system that enables the elimination of the conventional air and fuel emulsification systems in common carburettor use. The elimination of the air bleed/emulsion well/main jet principal in common use reduces the number of components and simplifies the tuning of the main fuel mixture and atomization jetting system.

The main fuel mixture control and atomization device can be inserted within a plate and may be held in place by the sandwiching of the layers of plates or plate to chassis sandwiching. A single bolt centrally located, supplies the force necessary to seal the plates thus decreasing the time spent to effect a plate change.

### DRAWINGS

### Figures

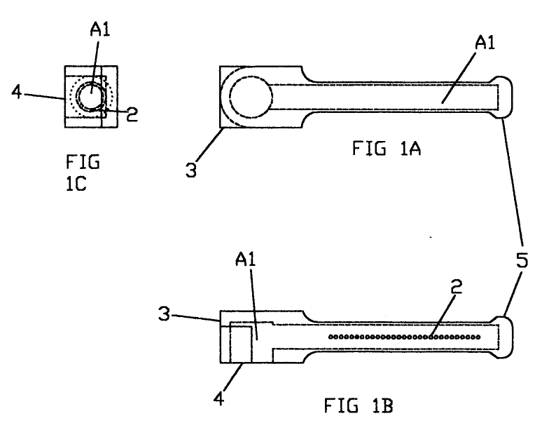

FIGS. 1A and 1B and 1C show the embodiment of a shaped tube to convey liquid fuel in flow capabilities sufficient to supply the dominant percentage of the fuel flow necessary for high horsepower production of an engine using this carburetor.

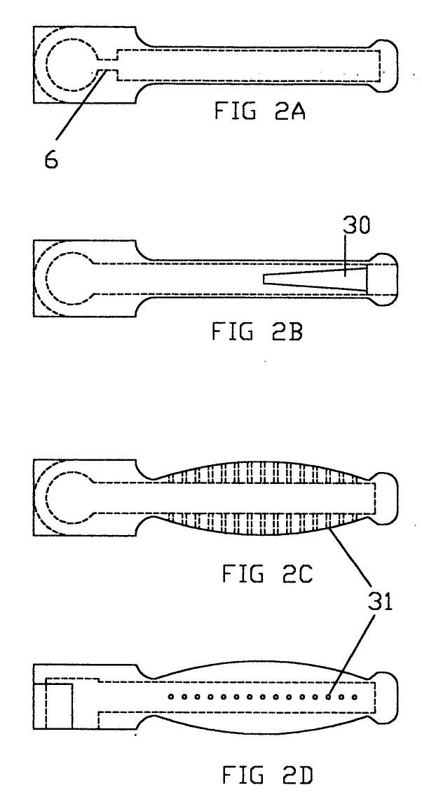

FIG. 2A shows a further embodiment, which is a variation of that shown by FIGS. 1A to 1C and includes a flow restrictive jet that may be used to cause a high flow rate leaning of the mixture.

FIG. 2B shows a further embodiment, which is a variation of that shown by FIGS. 1A to 1C and includes a flow restrictive plug.

FIG. 2C to 2D shows a further embodiment, which is a variation of that shown by FIGS. 1A to 1C and includes variations of fuel exit orifice length.

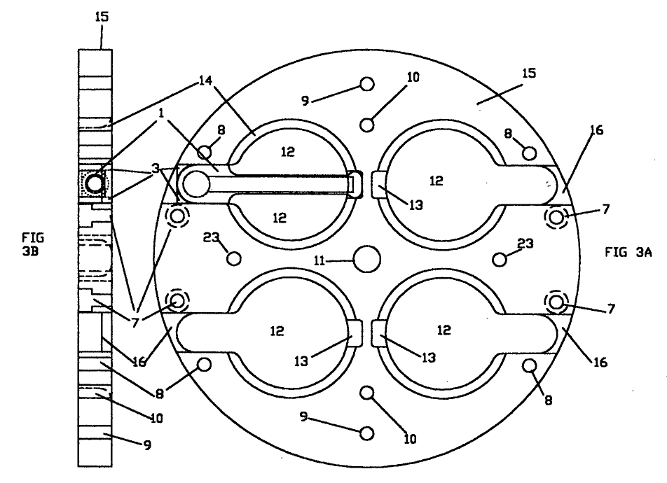

FIGS. 3A to 3C show the embodiment of a plate with four main airflow orifices and positions to screw in jets that predominantly control fuel and channels and holes to convey mixture. FIG. 3B is a side view of FIG. 3A. FIG. 3C is an end view of FIG. 3A

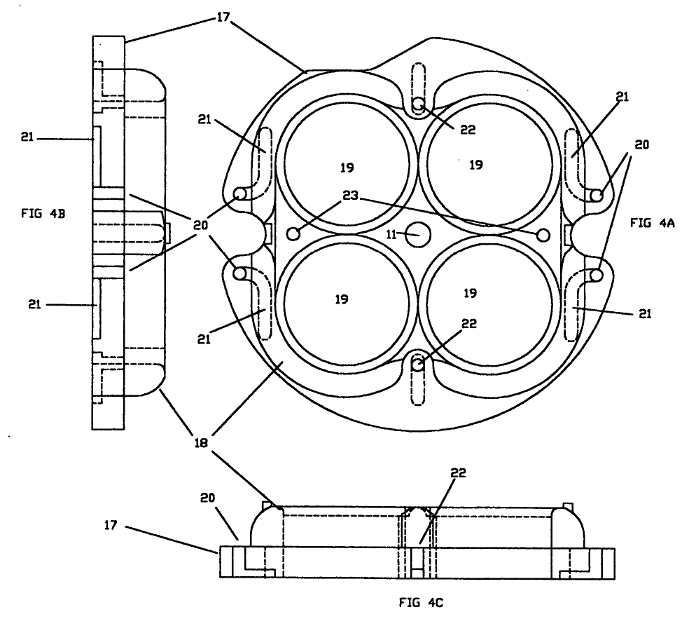

FIGS. 4A to 4C show the embodiment of a plate with four main airflow orifices or suction bores and positions to screw in jets that predominantly control air and channels and holes to convey mixture. FIG. 4B is a side view of FIG. 4A. FIG. 4C is an end view of FIG. 4A.

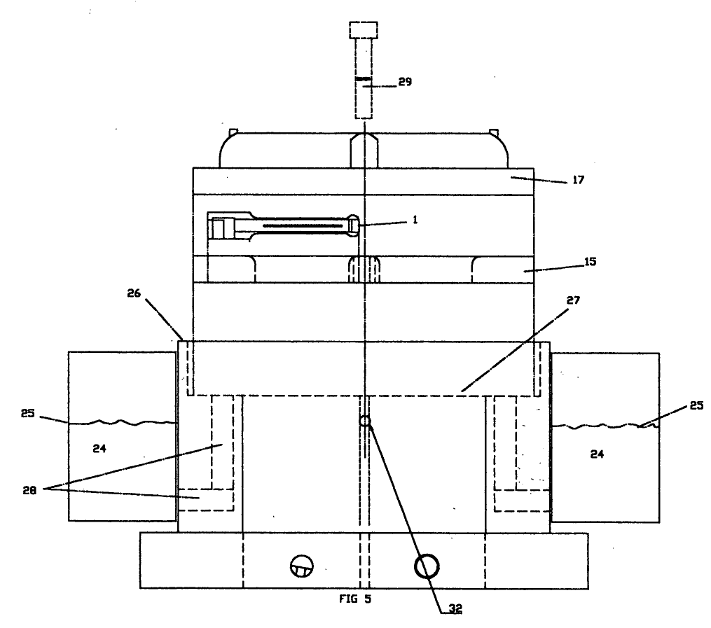

FIG. 5 shows the assembly of major components. The components are shown lifted upward from their assembled placement.

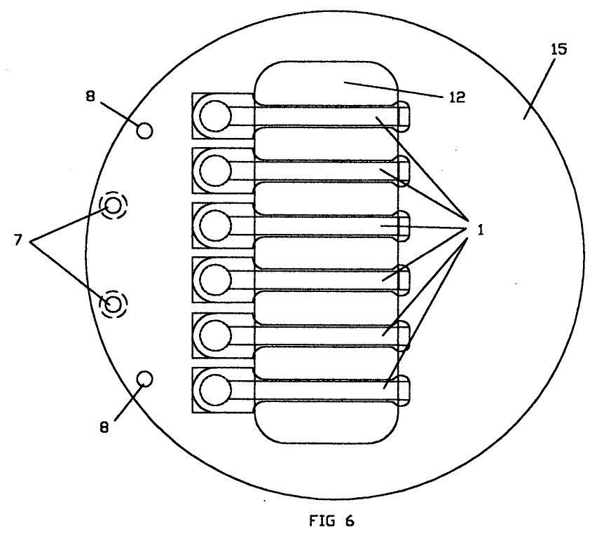

FIG. 6 shows a further embodiment of a plate with a single large main airflow orifice or suction bore fitted with six liquid distribution devices of FIG. 1A to 1C.

### REFERENCE NUMERALS

A1=internal chamber supplying fuel to the multiple liquid distribution devices.
1=liquid distribution device
2=jetting holes sized to use laminar flow phenomena as part of this invention.
3=tabs to locate entrance end of liquid distribution tube prior to and during assembly.
4=fuel inlet surface of liquid distribution device
5=end of liquid distribution device designed to support end prior to and after assembly.
6=additional jet restriction.
7=placement of idle-transfer fuel jet
8=hole to convey idle and transfer atomized mixture to base of carburetor.
9=hole to convey idle atomized mixture to top plate of carburetor.
10=hole to convey idle atomized mixture with optional idle mixture atomization air.
11=main hold down bolt location.
12=main airflow restriction orifice or suction bore.
13=notch to support end of liquid distribution device during and after assembly.
14=radius to smooth airflow into orifice.
15=jet plate; usually lightweight aluminum material.
16=ledge machined into plate to receive tabs at end of liquid distribution device.
17=aero plate; usually lightweight aluminum material.
18=aerodynamic shape to promote smooth airflow at entrance to carburetor.
19=airflow straightening orifice
20=idle transfer anti siphoning jet and or air bleed location.
21=channel milled on surface of plate to convey atomized fuel mixture.
22=location of idle mixture atomization air jet.
23=location of accelerator pump fuel distributor.
24=fuel in reservoir
25=nominal surface level of fuel.
26=air cleaner attachment surface.
27=receptacle area to receive plates.
28=fuel supply chambers or channels or drillings.
29=central clamping bolt.
30=flow restricting plug.
31=fuel exit to atmosphere orifice.
32=idle mixture adjustment screw location
33=throttle bore
34=mixture delivery hole to transfer slot
35=radius
36=registration surfaces
37=transfer slot
38=protruding machined key
39=threaded fuel inlet hole
40=machined hole and keyway socket
41=area match machined to throttle bore radius
42=liquid restricting jet
43=air restricting jet
44=low load fuel mixture outlet orifice.
45=restriction area to flow
46=air restricting jet
47=atomized mixture

### DETAILED DESCRIPTION

The present invention will become more fully understood from the detailed description given herein below and the accompanying drawings which are given by way of illustration only, and thus, are not limitative of the present invention and wherein:

The carburetor is constructed with a chassis to enable modular construction and assembly. The chassis section of the carburetor may hereafter be referred to as the main body or body or the middle section or the chassis. The assemblage of plates attached to the chassis forms the fuel mixture control systems and venturi. The fuel supply systems may be attached to the side of the chassis or via any other suitable method. A throttling plate may be attached to the base of the chassis to control the regulation of airflow rate through the carburetor. The throttling plate may contain inserted plates or devices to assist in control of fuel mixture. These plates may be quickly interchanged to affect a transfer fuel outlet tuning function or idle outlet location or other fuel and or air and or mixture supply location or operation.

The construction of the carburetor involves various levels and functions sandwiched on top of each other, with each level/functional unit easily and quickly removable and replaceable.

FIGS. 1A to 1C show views of a liquid distribution device. This device is the only form of jetting of the main fuel volume entering the airflow of the engine. Internal chamber A1 is filled with liquid fuel in response to the vacuum created by venturi action at the outlet holes 2. The liquid distribution device has location tabs 3 that allow the device to be held in place by gravity prior to assembly of the plates. A gasket to the chassis of the carburetor seals the surface 4 of the device so that fuel and or air is not leaked.

The radius 5 is used to support the end of the liquid distribution device prior to and during operation of the carburetor.

FIG. 2A shows a further embodiment that is a variation of that shown by FIGS. 1A to 1C and includes an additional jet restriction 6.

FIG. 2B shows a further embodiment that is a variation of that shown by FIGS. 1A to 1C and includes a restrictive plug 30, which is shown by way of example as a tapered plug.

FIGS. 2C and 2D show a further embodiment that is a variation of that shown by FIGS. 1A to 1C and includes variations in the length of fuel exit orifices 31.

FIGS. 3A to 3B show the liquid fuel distribution device 1 inserted within the plate 15. The machining at area 7 is to provide facility for a screw in jet. This jet controls the liquid fuel entering the low engine speed running circuits of the carburetor. These circuits are typically called idle and transfer circuits.

The hole 8 conveys an atomized mixture of fuel and air downward to the chassis of the carburetor. The hole 9 conveys atomized fuel and air mixture upward from the chassis of the carburetor. The hole 10 conveys atomized fuel and air mixture downward to the chassis of the carburetor. The chassis of the carburetor has continuations of these holes drilled through the material of the chassis. These continuations convey the fuel mixture to the throttling plate attached to the base of the chassis.

The hole 11 is a through hole for the central fixing bolt or stud. This fixing bolt provides the force necessary to seal the plate flanges to the respective gaskets and the chassis.

The orifice 12 is what is commonly termed the venturi. This orifice may or may not have the full form of a venturi shape.

The radius 14 is formed at the entrance of the orifice to smooth airflow into the orifice.

The area 13 is machined to allow the radius 15 on the end of the liquid distribution device to be supported before assembly and during use of the carburetor.

The area 16 is machined so that the tabs 3 locate upon the surface 16.

FIGS. 4A to 4C show a plate 17 machined for smooth airflow 18 into an orifice 19. The hole 20 is to receive a screw in air jet. The channel 21 connects the fuel exiting the jet shown at FIG. 3A 7 to the air stream exiting the jet at 20. The hole 22 is to receive a screw in air jet. The centerline of the jet at 22 is misaligned with the centerline of the hole shown at FIG. 3A 10. The hole at 23 is to convey fuel from the accelerator pumps mounted elsewhere on the carburetor.

FIG. 5 shows a general assembly view of a form of the carburetor that has been produced by the inventors. A fuel reservoir 24 is shown with the respective fuel surface labeled at 25. The plate 17 hereafter called an aero plate fits downward onto the plate 15 hereafter called a jet plate. The jet plate includes the liquid distribution device 1 that is sandwiched between the aero plate and the lower surface of the receptacle 27. The assembly formed by the aero plate and liquid distribution device and jet plate is sealed to the chassis receptacle surface 27 by the central bolt 29 and vacuums generated by the engine draw fuel into the plates and mixture forming circuits via the large holes 28. The depth of the receptacle in this example is selected to allow the top of the aero plate to be approximately level with the air cleaner mounting surface 26. The depth of the receptacle may be reduced in order to position the plates higher above the fuel level for additional g-force correction tuning if needed. An idle mixture adjusting screw is located at hole 32.

FIG. 6 shows a further embodiment of the jet plate 15 and the liquid distribution device 1. The jet plate is formed in this case with only a single airflow orifice or venturi 12. The orifice is fitted in this example with six liquid distribution tubes. Using this design of carburetor utilizes the advantages of platelet-venturi style carburetors.

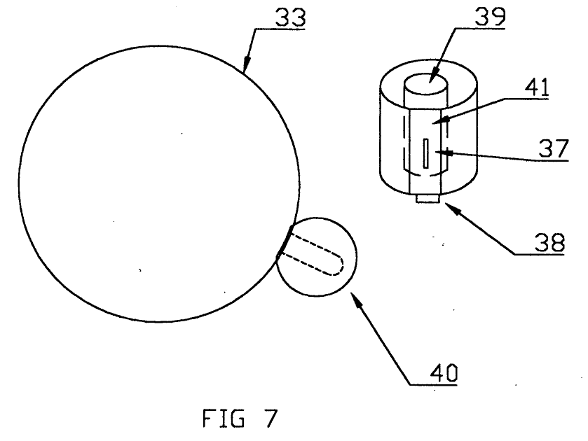

FIG. 7 shows a throttle bore 33. The opening direction of the throttle is not shown. Machined at 40 is a socket with a keyway socket at the base. Shown at FIG. 7B is an insert to fit the socket. The insert has a threaded hole to ease removal and also to convey fuel to the transfer slot 37 that is machined in the area 41 designed to match the throttle bore if necessary. The insert has a keyway 38 formed at the base so as to register the alignment of the insert.

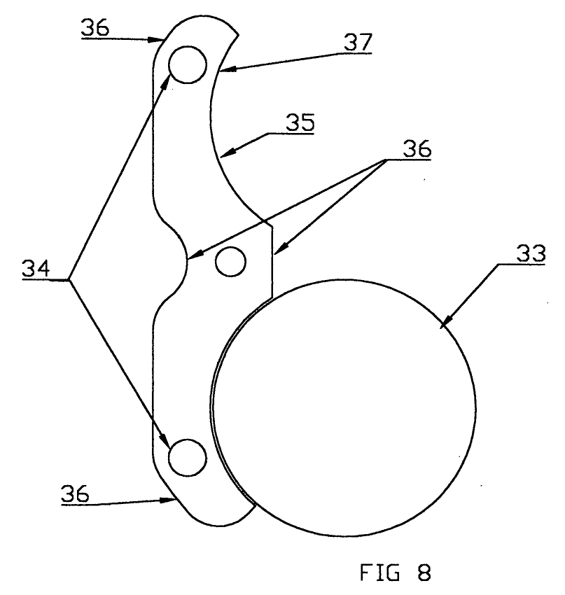

FIG. 8 shows a throttle bore 33. The opening direction of the throttle is not shown. This fig shows a different style of transfer insert. This insert covers two throttle bores with the one part. Item 34 is the fuel inlet holes to the transfer slots formed at 37 but not shown. Item 35 is a radius machined to match the throttle bore. Items 36 are registering areas of nominal shape; these registrations prevent the insert being incorrectly fitted.

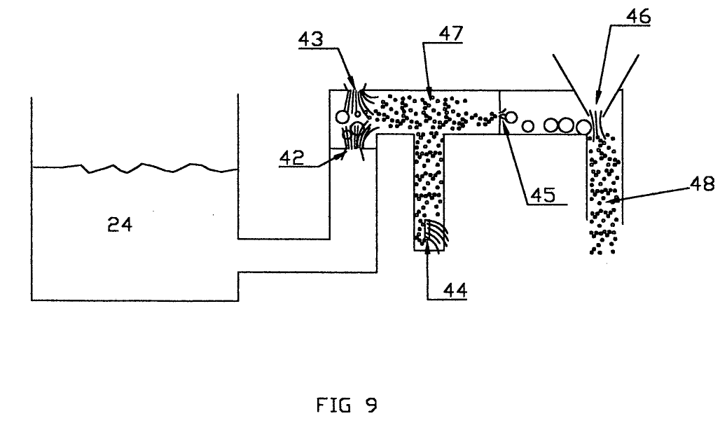

FIG. 9 is a schematic of an idle and transfer system. Item 24 is liquid fuel stored in a reservoir. The liquid is drawn into the jet 42 by vacuum from the engine (not shown) where the liquid stream is impinged by an opposing air steam exhausting from the air jet 43. This creates a fine atomized mixture 47. The mixture 47 is drawn into the low load orifice 44 where it exhausts into the throttle bore (not shown). The mixture 47 is also drawn through the idle mixture controlling restriction 45. After the mixture has exhausted from this restriction it is impinged upon by an air stream exiting the air restriction jet 46 resulting in the atomized mixture 48. This mixture 48 is drawn into the engine (not detailed)

Operation.

The inventor has developed a high flow rate, liquid fuel distribution device detailed in FIGS. 1A to 1C using multiple jetting holes 2 shown at FIG. 1B preferably but not limitedly sized within the range of 0.009″ to 0.025″ diameter and of preferably but not limitedly 0.020″ length arranged near equally spaced across an airflow orifice or venturi as in FIG. 3A. Each of these holes 2 may be referred to as a jet. The carburetor utilizes the well-known venturi principle to create sufficient vacuum to draw fuel from a supply reservoir shown in FIG. 5 labeled as 24. A practical form of the venturi effect is created when the liquid distribution tube is placed across the diameter of a straight bored hole. The venturi thus formed is in effect inside out compared to the normal method of manufacture of a venturi. The diameter of each jet may be different in order to control the flow rate of fluid at differing areas of the venturi thereby resulting in differing mixture supply curves. The diameter of each jet hole may be altered in order to increase or reduce the droplet size. Race tuned engines using this liquid fuel distribution device have shown considerable increase in power by using jet holes of 0.0156″ diameter spaced evenly across the venturi diameter. The inventor suggests using venturi diameters of 1 inch to 1.75 inches. An appropriate ratio of venturi area to jet area to use is 308 to 1. This ratio will enable most engines on various gasolines' to run for initial tuning purposes. Tuning of the mixture may be accomplished in many ways, more jet holes will richen the mixture; enlarging the jet holes will richen the mixture. Practical experimentation has shown that as long as the diameter and the length of the jet holes are kept within the dimensions necessary to utilize the physics phenomena of laminar flow within the jet orifice there is no need to use introduced air into the liquid flow to control the air fuel ratio from over richening as has been done in previous carburetion designs.

The internal and or external diameter of the liquid fuel distribution device may be altered to control the effect of one of the flow resistance areas. The internal diameter of the liquid distribution device is usually over the nominal dimension of 1 mm therefore it responds to the normal turbulent flow physics of long large tubes. Reducing the internal chamber FIG. 1B A1 cross sectional area causes a greater bend turbulence for any given flow and reduces flow non-linearly in relation to pressure differential. The effect of the turbulence is to cause a reduction of fuel to air ratio. The smaller the entrance diameter of the chamber the greater is the fuel to air ratio reduction at higher liquid flow rates. A shaft or tapered plug may be inserted into the internal chamber A1 from either end so that wall friction increases turbulence thereby altering flow characteristics. A single end tapered plug is shown as an example at FIG. 2B 30.

The wall thickness of the liquid fuel distribution device at the point where the fuel discharge orifice is formed may be altered to control the effect of one of the flow turbulence resistance points. A thicker wall may due to the length of the orifice have a greater friction component for any given flow. Some jet holes may utilize the described laminar flow and others may be designed to not.

The point upon the circumference of the liquid fuel distribution device where the fuel orifices are formed may be altered to control the pressure differential and or the speed of airflow past the orifice. The inventor suggests placing the centerline axis of the jet holes at 90 degrees to the centerline axis of the airflow orifice or venturi. The shape of the air flowing orifice or venturi may be altered to control the pressure differential along the liquid distribution device.

The point upon the length of the fuel distribution tube where the fuel orifices are formed may be altered to control the amount of pressure differential upon each individual orifice. An orifice that is placed near the wall of the venturi will deliver fuel in response to a lesser pressure differential due to the reduced velocity of the air stream at the wall of the venturi.

We seek to prove that the design of this carburetor is inventive over previous fixed venturi designs that have purposely introduced air into the fuel stream before the fuel interaction with the atmosphere in the venturi. It has been experimentally demonstrated that the air fuel ratio delivered by this carburetion principle is essentially flat throughout the designed air flow ranges of operation of the liquid distribution device and that this exceptional result is achieved without air correction techniques or devices that restrict flow from the outlet jets. The device for main fuel mixing and atomization ideally causes the fuel to exit into the air stream at approximately 90 degrees to the air flow direction, therefore creating the maximum shearing of the fuel into droplets. When the fuel exits the orifice at 90 degrees to the air stream the fuel acceleration required in the atmosphere to meet the air speed is increased. This increased acceleration rate occurring in the atmosphere requires a greater energy input to the fuel from the atmosphere of the venturi and therefore greater heat transfer from the atmosphere occurs. Higher vaporization influences the equality of fuel to air ratios delivered to the cylinders of a multiple cylinder engine. Equality of mixture distribution is improved by achieving higher levels of vaporization. The effect of higher vaporization of the fuel is to promote a more consistent cylinder distribution of the fuel to air ratio because vaporized fuel behaves in a similar way to the air flow patterns whereas fuel that is present as a liquid is subjected to greater inertia influences.

A simple method of constructing the venturi is to bore a straight hole and insert a round tube at right angles to the bored hole. The tube has holes drilled in it to preferably utilize the physics phenomena mentioned. As the engine operation draws air through the carburetor, airflow around the tube becomes sufficient to create a vacuum able to draw fuel at air fuel ratios designed for combustion. One embodiment of the liquid distribution device jets the fuel at the point of interaction with the atmosphere of the venturi without prior introduction of air or use of a jet prior to the atmosphere interaction point. The elimination of the air bleed/emulsion well/main jet principally in common use by existing carburetor manufacturers reduces the number of components and simplifies the complexity of tuning of the main fuel mixture and atomization jetting system. An unskilled person can replace the liquid distribution device with a richer one and run the engine with the assurance that the air fuel ratio is truly a similar amount richer at all points through out the air flow requirement of the engine. The airflow requirement through the venturi to cause fuel flow to occur from the liquid distribution device is the same irrespective of the jet mixture ratio and the idle transfer circuit is separated from the liquid distribution device circuit. This means that the tuner only has to tune the idle transfer circuit first and then the liquid distribution device for a consistent blend of operating airflow ranges. In practice this means that if the liquid distribution device mixture strength is altered there is no effect on the idle and transfer mixture strength. The liquid distribution device method is much simpler and more logical to understand than the complexities of multiple circuits and air bleeds interacting with one another at all airflows. The inventors have found during testing that the exhaust gasses emitted from test engines fitted with the carburetor of this invention have a generally lower concentration of environmentally harmful gasses and the oxygen consumed is reasonably constant throughout the range of load and operation of the engine. This result is the desire of most carburetor manufacturers and or tuners and the advantage of this carburetor is the simplicity of design and use and ease of manufacture to achieve this result.

The fluid flow pattern through a venturi is distinctly different to the fluid flow pattern through an orifice. A venturi has a diverging tail section formed after the point of maximum restriction, this tail section controls the velocity of the fluid stream so that the velocity is reduced efficiently and minimum overall flow restriction occurs through the venturi. An orifice does not have this tail section and the fluid is released from the maximum restriction point into a possibly uncontrolled space. When liquid flows through an orifice of the liquid distribution device and enters the atmosphere a vena contracta occurs. The vena contracta is caused by the inertia of the liquid, which continues to converge after passing through the orifice. As long as it continues to converge, the velocity head increases and the static pressure head decreases. The minimum pressure head therefore occurs at the vena contracta that is within the unrestricted atmosphere space. This low-pressure zone of liquid results in greater shearing and atomization and vaporization of the liquid fuel. This effect contributes to the power increase of engines using this carburetor.

One of the factors affecting the pressure gradient of air flowing through a venturi is the friction of the air in contact with the walls of the venturi. This pressure gradient may be measured in any direction. The pressure gradient measured as a cross section through the venturi will be different at any place along the venturi. This is due to changes in friction and conversion of pressure to velocity associated with length and diameter of the venturi. When a fuel carrying tube is placed across a venturi or a straight bored hole and the tube is formed with a multitude of holes displaced across a chord formed, the fuel exits each of the holes in response to the pressure gradient at the fuel exit point. When sufficient numbers of holes are placed across the chord the fuel to air ratio is more consistent than a single point sensing tube. The need for auto-correcting principles is reduced.

Another advantage of this innovation is that the fuel droplets, by exiting into multiple areas of the venturi, are in contact with a greater amount of unmixed air. Unmixed air may be considered to be drier and warmer relative to air that has been in contact with fuel and thus cooled and moisturized by the percentage of vaporized and liquid fuel present. Because this innovation saturates the air in contact with the fuel droplets at the early stage of mixing in the carburetor the energy potential for vaporization is increased. The rate of vaporization of a droplet of fuel is due to the energy transfer rate between the fuel droplet and the surrounding atmosphere. Therefore small multiple droplets of fuel totaling a given mass will expose a greater surface area of liquid to the atmosphere compared to a single large droplet of fuel of the same mass. This increases the total energy transferred into a given quantity of fuel resulting in a higher percentage of vaporized fuel in the intake system. The droplet size is influenced by the diameter and placement of the liquid outlet holes in the liquid distribution device. Small holes give rise to small droplets.

The simplicity of this fuel metering system enables the entire main fuel supply metering equipment to be contained in a small depth of air metering orifice, typically but not limited to the range of 15 mm to 25 mm in depth. This enables the air restriction and fuel metering system to be formed entirely in a removable plate. The distribution tube may be vertically or horizontally or obliquely mounted whereas emulsion tubes of conventional carburetors generally have to be arranged in a vertical configuration so that as the fuel level changes within an emulsion tube, more or less air introduction holes are exposed. A limitation of the conventional emulsion tube is the mixture delivered from the tube is influenced considerably by the head of pressure variation upon the main jet at the entrance to the emulsion well interacting with the introduced air from the emulsion air bleed locations. The head of pressure at the main jet varies usually as a result of g-force action within the float bowl. The absence of air bleeds in the liquid distribution tube concept presented in this application has been shown in practical experiments to provide less mixture variation due to g-force influence than the conventional emulsion well in common use. The limitations of conventional emulsion tubes adds vertical height to the metering system whereas the distribution tube described may be held horizontally by the plates reducing the vertical height of the carburetor and allowing simple removal of the plates and or the distribution tube.

Multiple plates preferably located above the normal fuel level of the carburetor may be pre set with different combinations of features and quickly changed for testing or improvement of the engines performance. The plates may also be installed on top of one another to affect fuel ratio control. This stackable feature may also be used in conjunction with combustion enhancing substances such as nitrous oxide gas or nitro methane fuels. Introducing nitrous oxide gas and the correction fuel necessary can be done in a plate above the throttling valves and or above the main venturi or airflow orifice's. This improves cylinder distribution of these power enhancing fuels and additives and offers the additional advantages of carburetion of the fuels and gasses.

The surfaces of the plates may form fuel and or air conveyance passages. These passages may be formed by simple milling operations such as milling a channel upon the contact surfaces of the plates or by photo etching processes. FIG. 4C 21 shows a curved passage milled into the surface of the plate, the curvature of the passage and the distance apart of the two side walls of the passage may be used to promote turbulence and or flow using similar knowledge to conventional porting techniques for cylinder head ports. The passages may also be formed during casting or injection molding process. A gasket or other conventional form of surface sealing may form a chamber in conjunction with the passages and be able to hold fuels and air from leakage to undesired areas and may also seal the contact surfaces of the multiple plates. The clamping force achieved by bolting the multiple plates to the body of the carburetor has been found to be sufficient to form an effective seal.

The removable plates may contain other components of the operation of the carburetor. These components may form all or part of the engine idle system or all or part of the engine slow running above idle speed system. These systems are generally used to supply fuel at correct ratios to the engine at air velocities that may be too slow for the main supply system to operate efficiently. The idle system has been improved by re-atomizing the idle fuel after it has been passed through the mixture adjusting restriction. The idle system consists of an air bleeding jet and a mixture adjusting screw. The carburetor presented has the additional feature of an air bleed jet FIG. 4A 22. This air bleed is positioned so that the outlet stream of air has a shearing action upon the fuel entering the hole in the plate of FIG. 3A 10. An example of how to maximize shearing action is to align the centerline of the air jet with the circumferential edge of the exhausting bore communicating with the manifold of the engine. This shearing action upon the fuel combined with the additional air traveling down the hole through the chassis result in the idle fuel system having more vaporization than in a conventional carburetor. The idle fuel mixture is exhausted from the chassis of the carburetor into a registered hole drilled through the throttling plate. This exhausting location has been found to provide more even idle mixture distribution to the cylinders.

The slow running above idle speed system (commonly and hereafter referred to as the transfer system) consists of an air bleeding jet and a fuel jet. The transfer jet FIGS. 3A and 3B 7 is registered with the transfer air bleed FIG. 4A, 4B, 4C 20. The directly inline registration of these two jets causes the fuel mixture to be atomized by the directly opposing fuel and air streams exiting the jets.

The carburetor may contain a jet in a removable plate or in the body that controls an amount of air flow bypassing the throttling valve from the upper side of the throttling valve to the lower, engine vacuum side. This jet is not illustrated. The principle of allowing airflow to occur through a drilled hole in the throttling valve in order to perform the adjustment described is in common use however this procedure is limited and time consuming to alter or tune as it is usually done by drilling a hole in the butterfly valve. This jet may be called the butterfly angle compensation jet. Adjustment of this jet is used to alter the angle of the blade of the throttling valves and still achieve a correct idle speed for the engine. The inlet air flow to the jet is received from a position of air flow either before or after the main liquid distribution device and the outlet of air flow from the jet is below the throttling plate butterfly and positioned so as to even the mixture distribution between cylinders of the engine. This control is used independently from the idle speed adjustment screw common to all carburetors.

FIG. 6 is an example of this invention incorporating advantages of the platelet-venturi style of carburetors. However the number of components is greatly reduced compared to an example platelet-venturi carburetor such as U.S. Pat. No. 3,914,347 Kors et al. Oct. 21, 1975. This patent states on page 5 lines 14 to 24 that the airflow losses of the design are estimated at 3.0″ hg. It has been experimentally determined that the inventors carburetor does not need to suffer this great amount of pressure loss. Normally a carburetor that is large compared to the engines full throttle requirement will cause an effect commonly referred to as “the engine is over carbureted”. This effect is caused by the lack of pressure differential through the venturi and associated lack of atomization. The airflow loss figure quoted in U.S. Pat. No. 3,914,347 is a relatively normal figure for all existing carburetor designs. The inventors' carburetor provides sufficient atomization for good engine operation at less airflow losses than other carburetor designs. In practice an engine can be fitted and operated with a carburetor that would be considered to be too large if of existing designs.

FIG. 7 shows an insert that contains a transfer slot. Item 33 is a throttle bore modified with the socket 40 that has an example registration keyway at the base of the socket. The key 38 on the base of the insert registers the alignment of the transfer orifice 37 and the machined area 41 relationships to the butterfly valve. Item 39 is a treaded hole to enable a simple tool inserted for removal and also to convey fuel to the transfer orifice 37. This removable insert feature of the carburetor enables ease of tuning the transfer slot fuel curve. The transfer slot can be modified on a workbench or other machinery with accuracy and ease or replaced quickly with a different insert. The orifice design of the transfer slot is an important jetting tool for the fuel flow curve of the low load running conditions of the engine. The transfer orifice provides sufficient fuel for engine operation before the airflow through the main airflow orifice is sufficient to provide fuel flow through the main liquid distribution device.

FIG. 8 is an insert that covers multiple throttle bores with the one insert.

FIG. 9 details an improvement to a common idle-transfer system. Engine operation creates vacuum in the manifold (not shown) below the idle outlet chamber 48. Fuel is drawn from the reservoir 24 through the transfer jet restriction 42. Air is drawn through the air bleed 43. The mixing of the streams exiting 42 and 43 create small droplets of fuel 47. The droplets exit into the manifold at the transfer exhaust 44. The fuel droplets also pass through an idle restriction for idle mixture trimming adjustment. This causes the atomization to be reduced as shown by the drawing of the larger droplets exiting the restriction 45. The fuel droplets are re-atomized by the air stream drawn in from the extra air bleed 46 after they have exhausted from the idle mixture restriction 45. It has been found by the inventor that the atomization quality of the idle mixture fuel outlet is reduced when the carburetor is operating at loads above idle. This is due to the near equalization of pressure on either side of the idle mixture restriction and a corresponding reduction of velocity through the idle mixture restriction. Adding an additional idle air bleed jet has improved the mixture quality at idle and at loads above idle. The air stream exiting the jet is preferably positioned so that a shearing action upon the fuel stream exiting the idle restriction jet occurs. The idle system contributes fuel to an engine even at full throttle so improving the fuel condition is beneficial at all loads.

I claim:

1. A fuel mixture control technique comprising:
a. Suction bore.
b. A fuel in fluid form.
c. A means of fuel supply to a fluid distribution device.
d. Said fluid distribution device disposed across said suction bore having a plurality of orifices extending along a substantial portion of the length thereof and transversely to the longitudinal extent of said suction bore, said orifices having a predetermined length and diameter to cause laminar flow of said fuel within said orifices.

2. A carburetor comprising a removably received fluid distribution device of claim 1.

3. A carburetor comprising said fluid distribution device of claim 1 removably received in a removable plate.

4. A carburetor comprising said fluid distribution device of claim 1 removably received in a removable plate that is secured in a position above the normal fuel level.

5. A carburetor comprising said fluid distribution device of claim 1 removably received in a removable plate that is secured in a position above the normal fuel level, said removable plate containing predetermined air flow aperture and other liquid regulation jets and a further removable plate containing main air flow aperture and air regulation jets.

6. A carburetor comprising a butterfly valve for throttling purposes, having a low load fuel supplying orifice in the conventional position near the butterfly throttling valve and having the improvement of the low load fuel mixture-supplying orifice contained within a removable insert.

7. An idle mixture control system comprising in part an idle mixture adjusting restriction and with the improvement of an additional air jet positioned to re-atomize droplets of fuel after the fuel has passed through said mixture adjusting restriction.

8. A carburetor comprising the fuel mixture control technique of claim 1 and the removable insert containing the low load fuel supplying orifice of claim 6 and the idle mixture control system of claim 7.
